(19) United States
(12) Patent Application Publication
(10) Pub. No.: US 2002/0129364 A1
(43) Pub. Date: Sep. 12, 2002

(54) On-screen display area enabling media convergence useful for viewers and audio/visual programmers

(75) Inventors: Sharleen Smith, New York, NY (US); Wayne Chang, New York, NY (US); Ruel Espejo, New York, NY (US); Yaron Ben-zvi, New York, NY (US); Liam O'Malley, New York, NY (US); James Biggar, Cambridge, MA (US)

Correspondence Address: HARRINGTON & SMITH, LLP, 4 RESEARCH DRIVE, SHELTON, CT, 06484-6212, US

(73) Assignee: O2 Holdings, LLC, New York, NY

(21) Appl. No.: 09/991,416

(22) Filed: Nov. 16, 2001

Related U.S. Application Data
(60) Provisional application No. 60/253,105, filed on Nov. 27, 2000.

(51) Int. Cl. G06F 13/00

(52) U.S. Cl. 725/37

(57) ABSTRACT

A method and system is disclosed for displaying a program, commercial or a promotional message to a viewer of a viewing appliance. A method has steps of transmitting a television signal such that a display screen displays live or pre-recorded audio/visual programming; and opening a visually distinct on-screen area, region, window or stripe on the display screen upon command of the viewer, the on-screen area displaying information that provides the viewer with a capability to interactively obtain selected information from an information provider through a data communications network, such as the Internet, or to participate in an interactive application, such as a poll. The method implements steps of sending a first trigger signal (a VBI trigger) from a server for prompting the viewer to select whether the viewer wishes to have the on-screen area displayed during a program and, if the viewer so wishes, operating an input device for sending an affirmative signal to the viewing appliance. The receipt of the affirmative signal causes the viewing appliance to send a response signal to the server which, in turn, sends a second trigger signal to the viewing appliance for causing the viewing appliance to open the visually distinct on-screen area, region, window or stripe on the display screen of the information appliance.

### FIELD OF THE INVENTION

This invention relates generally to methods and systems for delivering information to a viewer of television programming and, more particularly, relates to audio/visual programming, to the Internet and other on-line services, and to an ability to deliver user-specified information to the viewer, wherein the information is related to one or more aspects of the audio/visual programming.

### BACKGROUND OF THE INVENTION

Television programming is well known and wide spread. Traditionally, television programming has been comprised of entertainment and informative segments that are typically referred to as “programs” or “shows”.

With the recent increase in usage of the Internet and other on-line services it has become known to display, with a television program that is currently being viewed, textual input from the viewers, via their computers and an Internet server or a site, such as a “chat room”. For example, a system known as Cod-i-chat™ (available from Callaway GraphicSoftware (callawaygs.com)) provides an on-screen ability to roll (vertically) or crawl (horizontally) Internet-derived chat names and text with a television segment that is currently being transmitted to viewers. In this manner it is said that one is enabled to involve viewers with the programming. In one application of this technique, a third of the screen is dedicated to displaying the chat names and text, with the remaining two thirds displaying the television programming. For the case of prerecorded broadcasts of some programs, an interactive, substantially real-time Internet chat “conversation” between viewers/Internet users and cast members can occur, with the conversation text being displayed to all viewers.

While this technique may represent a first step towards integrating television programming with Internet usage, it does not address the problem that can arise when a viewer desires to access the Internet or some other on-line service during the television program. For example, if the viewer is presented with a Uniform Resource Locator (URL) as part of the programming, or as an adjunct to the programming, and if the viewer desires to access the URL, then the viewer is presented with the choice of locating pen and paper to record the URL for later use, or accessing the Internet immediately during the program. In many instances another device is required to access the Internet, typically a PC, and thus the user can be temporarily distracted from the television programming and/or advertisements.

A technique for achieving limited interactivity with a viewer is provided by Wink (http://www.wink.com). Wink provides a development system where a developer creates a Wink application using proprietary software and then sends the application file to Wink for quality assurance and specification fulfillment. Wink is limited in some respects to the conventional ATVEF capabilities of WebTV or AOLTV as it is not a web page on television. As such, colors, functionality, and file size are limited. Wink also has no back channel to the Internet and remains independent of the Internet..

After a particular Wink application has been approved it is embedded as a trigger into the video signal at line 21 (VBI). On the viewer end, it is assumed that the set-top box is one of a number that are Wink-enabled (e.g., DirectTV, General Instrument, Scientific Atlanta), and the cable provider is also assumed to be Wink-enabled.

Soon after entering a channel, a Wink ‘I’ icon pops up to prompt the viewer to interact. The small lag time between entering the channel and the wink icon popup is required for the application data to be transferred into the viewer's set-top box.

A Wink Response network enables the viewer to purchase, participate in polls and enter sweepstakes and free giveaways. The user input is taken and processed without the viewer having to enter in their personal information (all of this is already provided by their cable operator). This is not, however, a real-time two-way system, as a sweep is periodically made to gather submissions.

Wink is believed to have been employed by at least one programmer's channel where the Wink application prompts the user to enter in stock tickers, and the entered information is stored locally on that user's set-top box so that the tickers appear with the most up to date price quotes.

### SUMMARY OF THE INVENTION

The foregoing and other problems are overcome by methods and apparatus in accordance with various embodiments and aspects of this invention.

In a first aspect this invention provides methods and apparatus for enabling a user of a viewing appliance to interactively select information of interest for delivery by an information provider. A viewing appliance may include, but need not be limited to, a television monitor, a computer monitor receiving a video feed, or a wireless device having a display. In a presently preferred embodiment the viewing appliance has interactive capabilities, enabling the viewer to generate signals that are received by the viewing appliance or by some interactive module associated with the viewing appliance.

In a further aspect this invention provides methods and apparatus for enabling a content provider to receive, during the airing of a television program, one or more interactively generated requests from a television program viewer for selected information, to store and aggregate multiple requests received during the airing of the television program, and to deliver the selected information to the viewer, thereby implementing a store-and-forward functionality, or a “persistent storage” functionality.

In a further aspect this invention provides an on-screen area, region, window or stripe that may be present intermittently or persistently during television programming and that provides the programmer and/or advertisers a capability to interactively engage a viewer so as to receive requests for information, where the information is related in some manner to the content of a program or a commercial, and to store-and-forward the requested information, preferably electronically, to the viewer.

In a further aspect the teachings of this invention provide an on-screen area, region, window or stripe that can be present intermittently or persistently during television programming and that provides the programmer and/or advertisers a capability to engage a viewer so as to participate in an interactive application such as, but not limited to, an opinion poll.

It is another aspect of the teachings of this invention to provide an on-screen area, region, window or stripe that can be present during television programming and that provides the programmer and/or advertisers with a capability to engage a viewer so as to participate in interactive applications, such as polls, and/or to request and receive information related in some manner to a particular program or commercial, wherein the on-screen area is selectively displayed only to those viewers who request that it be displayed.

In accordance with yet another aspect of the teachings of this invention a predetermined on-screen area, region, window or stripe operates in accordance with an Advanced Television Enhancement Forum (ATVEF) standard, wherein triggers are sent to a viewing appliance during Vertical Blanking Intervals (VBIs), wherein the predetermined on-screen area is operated by the triggers so to be present during television programming only when requested by a viewer, and that beneficially provides a capability to engage a viewer so as to participate in interactive applications, such as a poll, and/or to request and receive information related in some manner to the television programming being watched by the viewer.

In accordance with a still further aspect of the teachings of this invention an on-screen area, region, window or stripe is presented during television programming upon request by a viewer and enables the viewer to initiate requests for specific items of information that are offered to the viewer through the on-screen area, region, window or stripe. Preferably the information is related in some manner to the content of a program or a commercial. A record of viewer requests are stored for a given program enabling an information provider to store-and-forward the requested information, preferably electronically, to the viewer. The viewer may further be provided with an opportunity to participate in an interactive application, such as a poll.

In accordance with one aspect of these teachings a method is disclosed for displaying a program, commercial or a promotional message, referred to collectively hereinafter simply as “programming”, to a viewer of a viewing appliance. The method provides for transmitting a television signal such that a first area of a television monitor or some other suitable screen displays a program or a commercial, and such that a visually distinct area, region, window or stripe of the screen can be opened upon command by the viewer. The window displays information that provides the viewer with a capability to interactively obtain selected information from an information provider through a data communications network, such as the Internet.

The method includes steps of sending a first trigger signal from an information source, referred to herein also as a server, for prompting the viewer to select whether the viewer wishes to have the on-screen area displayed during a program and, if the viewer so wishes, the viewer operates an input device for sending an affirmative signal to the viewing appliance. The receipt of the affirmative signal causes the viewing appliance to send a response signal to the server which, in turn, sends a second trigger signal to the viewing appliance for causing the viewing appliance to open a window on the viewing screen of the information appliance. In a preferred, but not limiting, embodiment the window is translucent or transparent so that the television program may still be viewed through the window. The window may include various icons and other visual landmarks, as well as text, that in one embodiment offers the viewer an opportunity to obtain further information regarding some aspect of the content of the program being viewed. As but one example, if a topic of the program being viewed concerns early childhood development, the viewer may be offered the opportunity to obtain a report or a booklet on infant care. If the viewer decides to accept the offer, the viewer indicates acceptance by manipulating the input device in an appropriate way, such as by “clicking” on a displayed icon associated with acceptance. At this time the window may be automatically closed until some later time in the program when another topic is presented for which additional information is offered. When the viewer indicates acceptance a signal is sent from the viewing appliance back to the server, which records the viewer's acceptance for that particular additional information. This process may be repeated some number of times during a given program, with the server storing a record of the viewer's selections. At the end of the program the server may send a further trigger signal to the viewing appliance that causes the appliance to open the window (if not already opened) and to display summary information regarding the viewer's information selections. The viewer may be given the opportunity to edit the summary information so as to delete or add to the viewer's information selections. The viewer can also be prompted to enter some form of identification, such as a preassigned account number or a member number, or an address, such as an e-mail address or a physical street address, where the selected information is to be sent. The entered identification is sent to the server which then forwards the selected item(s) of information to the viewer. For example, the server e-mails the selected item(s) of information to an e-mail address entered by the viewer, or to an e-mail address that was previously entered by the viewer and stored by or for the server. The process can then be repeated for a next program. In this manner the server stores and aggregates, preferably but not necessarily on a program-by-program basis, a viewer's selections for additional information, and then forwards the information selected by viewer.

It can be appreciated that the additional information selected by the viewer can be in the form of, by example, an in-depth report, a coupon, or a list of locations where a particular item may be viewed or purchased.

The viewer can also be prompted to participate in an interactive application, such as an opinion poll, whereby the viewer enters a response to some question presented in the on-screen window. The response of the viewer is transmitted back to the server, which accumulates and tallies responses from multiple viewers, and which may then transmit the results back to the interactive viewing appliance for presentation to the viewers. This can occur in real-time or substantially real-time.

It can be appreciated that the use of the on-screen interactive window enables the audio/visual programmer to create “appointment-oriented” interactivity by scheduling specific interactions to occur during specific broadcast segments.

By giving the viewer the choice as to whether to display the on-screen window during a particular program the viewer is not forced to accept, view or use the on-screen window, and the viewer may watch the program uninterrupted and undistracted. If the viewer does select to use the on-screen window, then the viewer can be enabled to pick and choose what additional information to save, and to have the saved information forwarded by e-mail or by some other delivery technique to themself (or to someone else). The forwarded information may be in a format that enables review and viewing in a more optimized environment, such as on a PC or a workstation, or on any other type of computer appliance having a display and possibly a printer, such as a color printer.

The interactions supported by the use of the on-screen window include, but are not limited to: providing more information (e.g., text); interactive options, including polls, quizzes and chat; links out to the Internet; and interactive advertisements and/or coupons.

In a presently preferred, but not limiting, embodiment of the invention the interactive methods and system are implemented using technology that operates in accordance with the ATVEF standard, wherein triggers are sent to the viewing appliance during VBIs. The triggers may comprise URLs which are associated with the server, or with other servers. In response to receiving a trigger the interactive viewing appliance accesses the appropriate server to retrieve the desired content of the on-screen window. A particular server may be associated with a source of the audio-visual programming, such as a television network, or the server could be associated with a sponsor of the audio-visual programming, or the server could be associated with some other entity, such as a non-profit organization or a government agency.

During the display of the on-screen window the viewer is provided with a plurality of persistent icons. In the presently preferred embodiment these icons include an X icon enabling the viewer to close the on-line window at any time, a ? icon enabling the viewer to obtain Help, and an S icon enabling the viewer to access as an overlay an interactive summary page. The summary page can be presented to the viewer automatically at the end of the program, or upon viewer request during the program, for providing a summary of the various items of information that the viewer has previously selected to be forwarded.

The use of these teachings provides an on-screen region, preferably configured as a stripe that lies across the bottom of the screen display area, that holds and presents information that is contextual to the programming that it is overlayed on, and that provides user interactivity and an ability to request information related to a subject of or a topic considered by the programming.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is simplified block diagram of a system that is suitable for practicing this invention.

FIG. 2 is a simplified block diagram that shows in greater detail a portion (back end/infrastructure) of the system of FIG. 1, in particular a VBI-Trigger Insertion unit, and its connection with a Video Source. FIG. 2 also shows a depiction of a viewing appliance display screen (e.g., a television screen) that is partitioned between a programming area and another area, referred to herein for convenience as the interactive on-screen area, region, window or stripe.

FIGS. 3A-3F, referred to collectively as FIG. 3, depict various exemplary uses and modes of the on-screen window.

FIG. 4 illustrates scripts showing contents of the on-screen window during various Timecode segments of a program, as well as the associated VBI triggers generated by the VBI-Trigger Insertion unit of FIG. 2.

### DETAILED DESCRIPTION OF THE INVENTION

This invention will be described in the context of, but is not limited to, providing television signals containing programming, promotional messages and advertisements, in conjunction with an information-containing interactive on-screen window that may be periodically, sporadically, intermittently, or continuously present, and that covers some portion of the screen. The information appearing in the on-screen window may be relevant to all viewers, or it may be customized to be pertinent to a select group of viewers within a predetermined region, or age group, or some other demographic, or it may be personalized to be pertinent to a particular viewer or group of viewers.

While the content of the on-screen window is discussed below in the context of obtaining information for a viewer from an Internet site, all such references to Internet sites, URLs and addresses should be understood to also include other on-line sites, such as, but not limited to, Internet Service Provider and Internet Portal sites, such as, for example, America Online (“AOL™”).

This invention further provides an ability to perform “media casting” wherein, by example, the on-screen window is employed in the process of possibly printing out coupons or other promotional materials, as well as informational materials, that are related to an advertiser, to a programmer's promotional message, or to the content of the programming itself. The use of the on-screen window promotes convergence between different media (e.g., between cable television and the Internet).

The on-screen window may also display a logo, scheme, or an animation that becomes associated with the on-screen window and the programmer.

The teachings of this invention relate to any viewing appliance, not necessarily to just a television monitor. Other examples of suitable viewing appliances include, but are not limited to, a computer having a monitor that displays a video feed, a monitor that displays video feed, and a wireless device having a display for displaying a video signal.

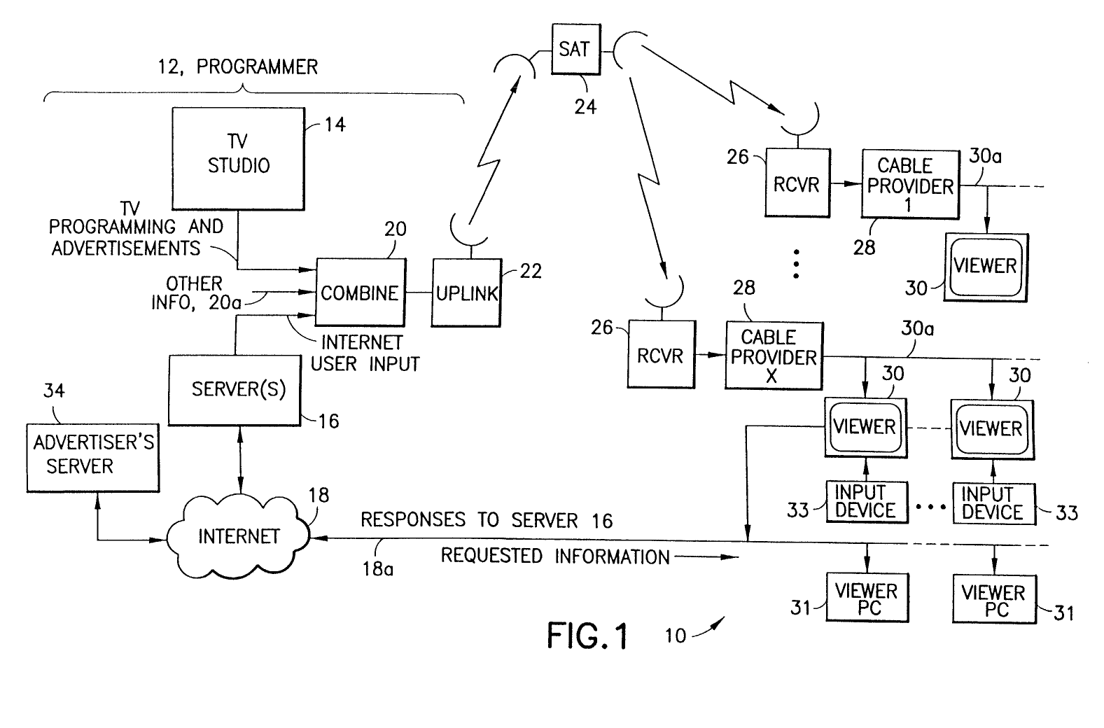

FIG. 1 is a simplified, general block diagram of a system 10 that is suitable for practicing this invention using interactive television, preferably, but not by way of limitation, an interactive television system employing ATVEF standards, formats and protocols.

It should be appreciated that in other embodiments of this invention other techniques can be employed to implement these teachings. These other techniques include, but are not limited to, the use of Advanced Television Systems Committee (ATSC) promulgated standards such as the Program and System Information Protocol for Terrestrial Broadcast and Cable (PSIP) (ATSC Document A/65A and Amendment No. 1), as well as the use of the Digital TV Application Software Environment (DASE) standard that defines a software layer (middleware) for enabling programming content and applications to run on a so-called common receiver.

With regard to ATVEF, reference can be had, for example, to a document entitled “Enhancing TV with ATVEF” by Jason Steinhorn and Mark Kohler (copyright © 1999 by Miller Freeman, Inc.) and to a document entitled “Enhanced Television: A Historical and Critical Perspective” The AFI-Intel Enhanced Television Workshop, July, 1999, (copyright © by the American Film Institute, Intel, Tracy Swedlow) for a discussion of enhanced television, the operation of VBI triggers and other related topics.

The system 10 includes a programmer 12 comprising a TV studio 14 that outputs TV programming, promotions and advertisements. The TV programming may be live or pre-recorded, while the advertisements are typically pre-recorded. In this embodiment of the invention the programmer 12 also includes or is coupled to one or more servers 16 that are in turn coupled to the Internet 18. The output of the servers 16 can be Web pages, e-mails and other forms of information specified as being desired by viewers 30 of the TV programming. A combiner 20 may be coupled to both the output of the TV studio 14 and the server 16 for merging or combining these two inputs into a unified programming/Internet user input video signal. The combiner 20 may also receive as an input other information 20a.

The video signal, along with the associated audio information, can be transmitted via an uplink 22 to a satellite 24. Typically the satellite 24 will be a geosynchronous-type satellite that provides coverage of a predetermined portion of the surface of the earth. Multiple satellites and uplinks could be used to provide wider coverage. In the presently preferred embodiment there are two uplink feeds, one for the East Coast of the United States and another for the West Coast. The satellite 24 broadcasts the television signal back to the Earth where it is received by authorized receivers 26. By example, individual ones of the receivers 26 may be associated with individual ones of television providers 1-x, such as cable television providers 28. In this example cable television providers 28 have cable lines 30a for providing the received broadcast video signal to individual ones of viewers via television monitors 30. Associated with the viewers are viewer Internet access devices, such as PCs 31, to which requested information can be delivered from the programmer's server(s) 16 and possibly also from other servers, such as an advertiser's server 34.

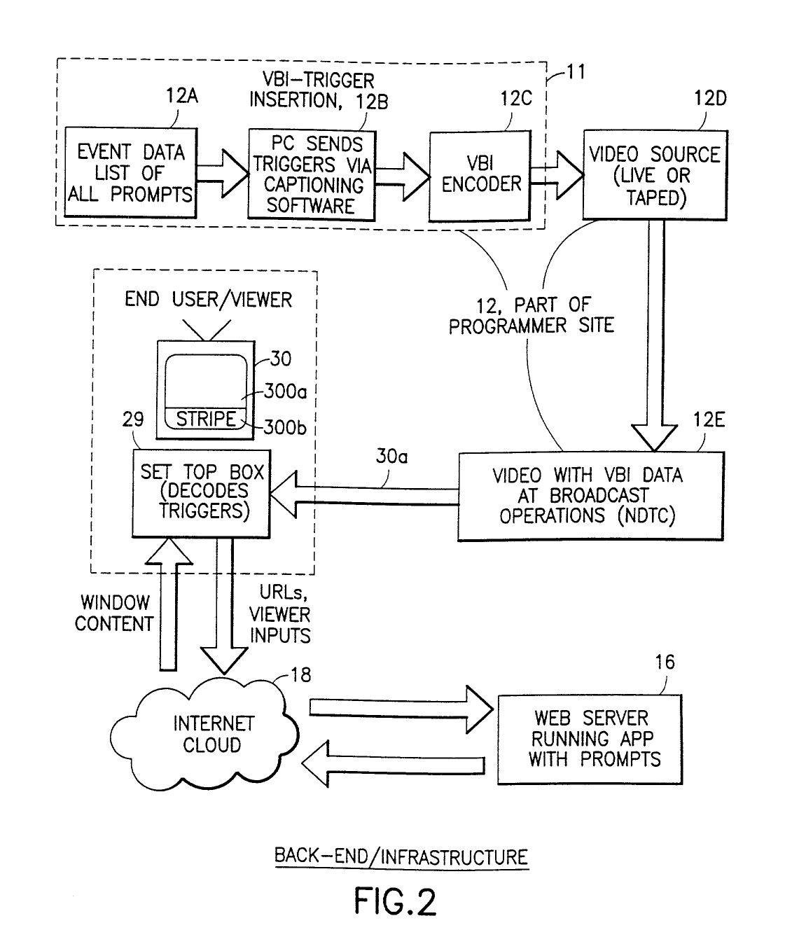

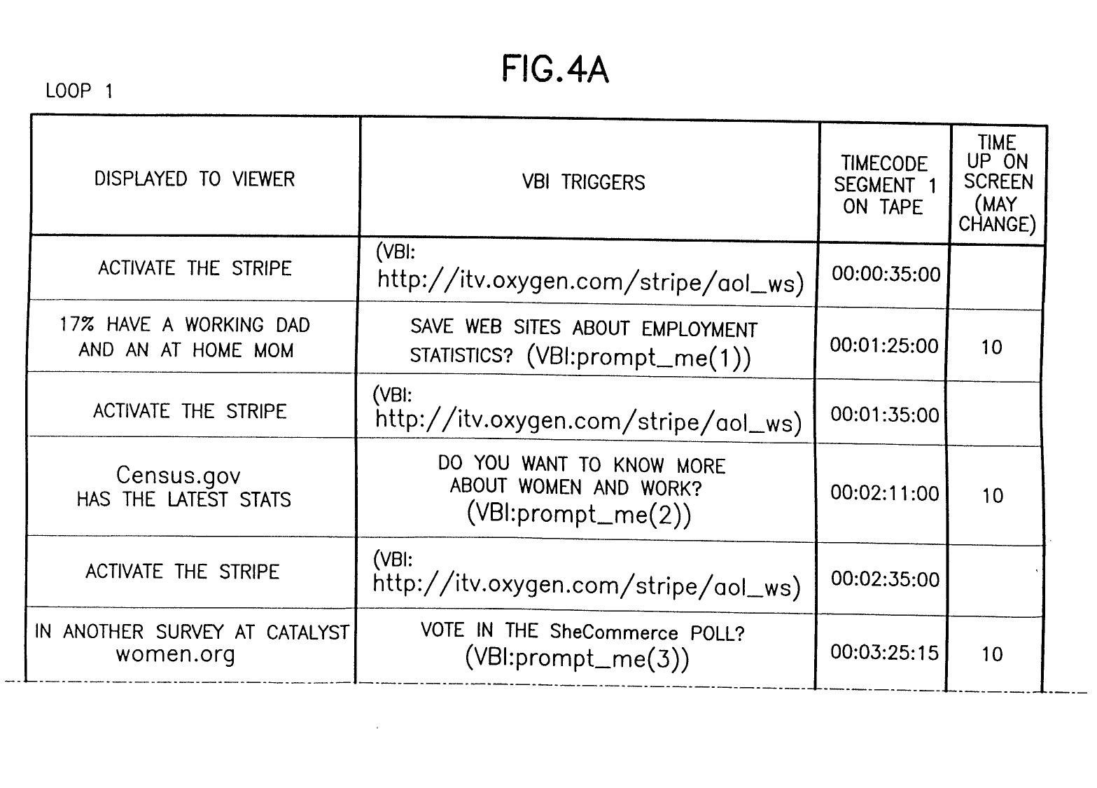

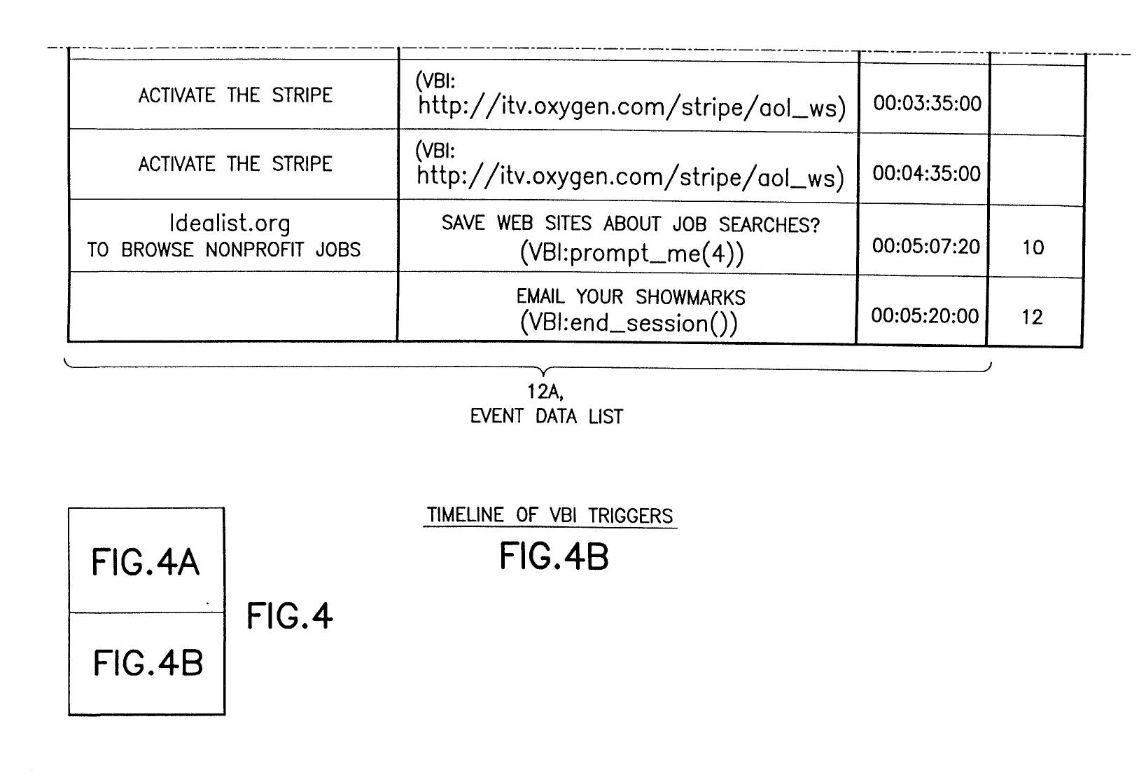

Referring now as well to FIG. 2, there is shown a simplified block diagram that depicts in greater detail a portion (back end/infrastructure) of the system 10 of FIG. 1, in particular a VBI-Trigger Insertion unit 11 that forms a part of the programmer site 12, and its connection with a Video Source 12D (live or taped video). The VBI-Trigger Insertion unit 11 includes an event data list 12A of all prompts (see FIG. 4), a PC 12B that sends VBI triggers via captioning software, and a suitable VBI encoder 12C. The output of the VBI encoder 12C (VBI triggers having the exemplary form shown in FIG. 4) is sent to the Video Source 12D, where it is combined with the live or taped audio/visual content of the current program and forwarded to a broadcast operations center 12E for distribution to cable providers 28 and other receivers of the audio/visual programming signal. Located at the end users/viewers are the viewing appliances 30 (e.g., televisions 30) and associated interactivity hardware 29, such as one provided by AOLTV™, where the VBI triggers are decoded. As is evident from FIG. 4, the VBI triggers include various URLs corresponding to the programmer's server (in this case designated “itv.oxygen.com”) wherefrom the interactivity hardware 29 retrieves the content of an on-screen window 300b, discussed below in greater detail, using the URL and the Internet 18. Other VBI triggers have the form of commands that are recognized, decoded and executed by the interactivity hardware 29, such as “prompt-me(n)”, where n identifies one of a plurality of questions posed to the viewers, and “end_session”, which provide a termination screen for the viewer to save selected web sites and other information, and to enter an e-mail or other address where the saved information is to be sent.

FIG. 2 also shows a depiction of the viewing appliance 30 display screen (e.g., a television screen) that is partitioned between a programming area 300a and another area 300b, referred to herein for convenience as the interactive on-screen area, region, window or stripe.

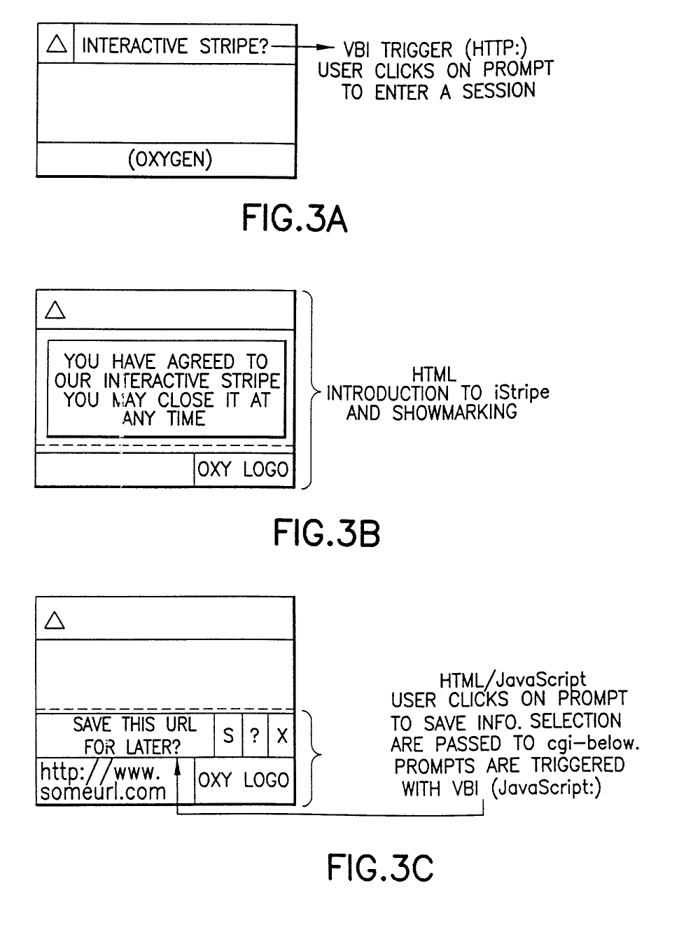

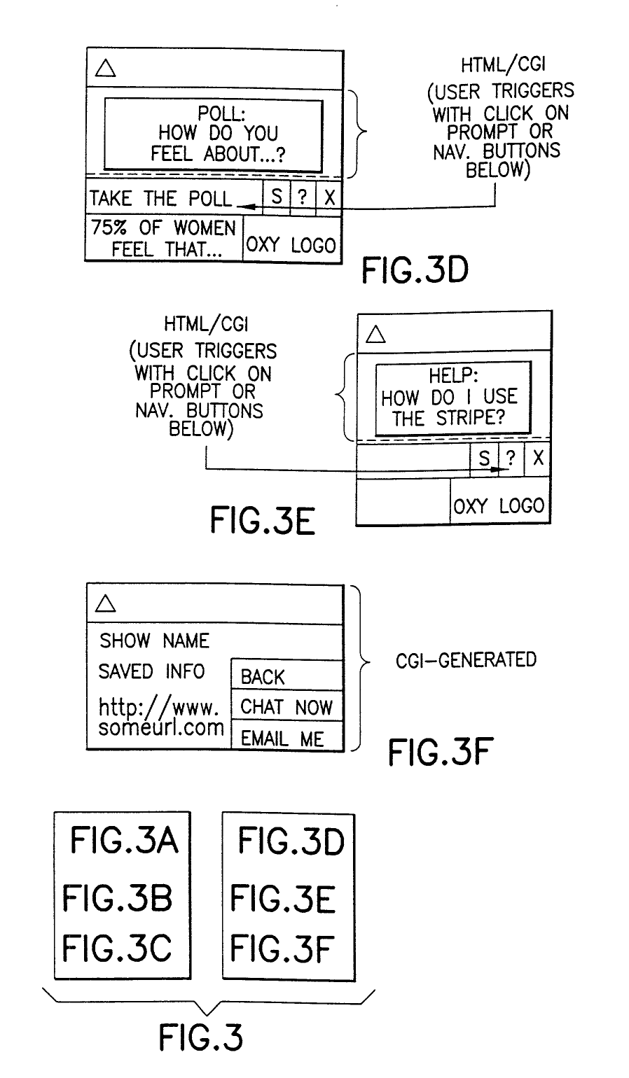

FIG. 3 depicts various exemplary uses and modes of the on-screen window 300b, where a first VBI-Trigger initiated screen (FIG. 3A) requests the viewer to select whether the interactive stripe or on-screen window 300b is to be activated for this program. If the viewer clicks on a prompt, using the input device 33 of FIG. 1, then a User Session is initiated for the program currently being aired. FIG. 3B depicts an introductory (HTML) screen, while FIG. 3C shows a HTML/JavaScript message displayed in the on-screen window 300b asking whether the viewer desires to save a displayed URL (someurl.com). At this point the viewer may click on the S icon to save the URL in the server 16, the X icon to close the on-screen window 300b, or the ? icon to obtain a Help screen (see FIG. 3E). The prompts are triggered with VBI (JavaScript:), and a viewer's selections are passed to the CGI. FIG. 3D shows the use of the on-screen window 300b for conducting a poll.

It should be remembered that the foregoing activity is taking place while the audio/visual programming (live or taped) is being displayed on the screen.

FIG. 3F illustrates a closing screen or a summary screen requested by the viewer, where the viewer can be presented with a name of the program or show that is currently under way or that is ending, a list of the saved information (selected by the viewer as in FIG. 3C), and a list of further selections. By choosing “Back” the viewer is returned to the program in progress, by selecting “Chat Now” the viewer is enabled to enter a chat session, or by selecting “Email Me” the viewer can be further prompted to enter an e-mail address where the URL saved in Step 3B will be sent. Selecting Chat Now and Email Me can cause the server 16 to erase all information saved thus far for this program. At the beginning of a next program the interactivity shown in FIGS. 3A-3F can be repeated.

In accordance with an aspect of this invention, the display screen of each of the viewing appliances 30 is divided or partitioned into the program/advertisement area 300a and another area, referred to herein as the on-screen window (or stripe or region or area) 300b. The on-screen window 300b is disposed, when displayed, at any convenient location on the display screen, and may have any suitable shape (e.g., square, rectangular, stripe-like, etc). In the preferred embodiment the on-screen window 300b is displayed so as to be at least partially transparent or translucent, allowing the television programming to be viewed through the on-screen window 300b.

Referring again to FIG. 1, and as was made apparent above, in response to the information found in the on-screen window 300b a particular viewer is enabled to request that a specific offered item of information be delivered to the viewer. This is accomplished using the suitable input device 33, such as a wired or wireless hand-held control unit as is known in the art of interactive television. The viewer's request is sent to the programmer's server 16 via the Internet 18 (indicated generally by the line 18a).

In response to receiving a request from a particular viewer the programmer's server 16 stores the request(s), aggregates the requests received during a particular program, and at or near the end of the program can display a summary list of information requested by the viewer. At this time the viewer may edit the summary list, such as by deleting one or more items of requested information, and then enters an address, using the input device 33, to which the requested information is to be delivered. In response to receiving the address, such as an e-mail address of the viewer, the programmer's server 16 delivers the requested information, such as by attaching the information to an e-mail, and sending the e-mail to the Internet 18. The viewer is then enabled to retrieve the e-mail and the requested information using the viewer's PC 31. The programmer's server 16 can thus been seen to operate in a store-and-forward manner. The programmer's server 16 may cooperate with other servers, such as the advertiser's server 34, during the above-described process. As but one example, a requested item of information may actually be delivered from the advertiser's server 34, or from some other server.

The viewers are also enabled to participate in interactive applications, such as opinion polls (see FIG. 3D), by entering responses to queries posed in the on-screen window 300b using the input device 33.

If the on-screen window 300b is being used in association with the viewing of a commercial, the offered and requested information may include, but is not limited to, ingredients, place of origin, specifications, usage or assembly instructions, availability, price and discounts, dosage instructions, known side effects, etc. The viewer could also be provided with a discount coupon, and/or location(s) where a certain product is available.

The content of the on-screen window 300b can be entered by an operator in substantially real-time, or it can be pre-recorded, stored in the Event data List 12A, and then merged with the on-air programming as was shown in FIG. 2.

Based on the foregoing description it can be appreciated that these teachings provide interactivity and enhanced television programming that is contextual to specific moments within a video feed. Furthermore, the use of store and forward aspects of these teachings enables the viewer to examine relevant information at a later time and in a different place that can be selected by the viewer so as not to interfere with the viewer's enjoyment of and engagement with the television programming. In addition, the use of these teachings enables the viewer to be prompted using a small translucent or transparent region or stripe that appears, in the preferred embodiment, at the bottom of the television screen in an unobtrusive manner.

It should be appreciated that while the invention has been particularly shown and described with respect to preferred embodiments thereof, it will be understood by those skilled in the art that changes in form and details maybe made therein without departing from the scope and spirit of the invention.

For example, while described above on the context of the use of ATVEF standards, formats and protocols, at least certain aspects of this invention can be implemented using the above-mentioned Wink system, as well as by using various digital television standards and protocols. Thus, it should be appreciated that the implementation of these teachings is not restricted to but one hardware/software platform, but may be implemented using various analog television and digital televison procedures and techniques.

What is claimed is:

1. A method for enabling a user of a viewing appliance to interactively select information of interest for delivery by an information provider, wherein the viewing appliance has interactive capabilities for enabling the viewer to generate signals that are received by the viewing appliance or by some interactive module associated with the viewing appliance during the display of programming content to the user, and wherein the user is prompted to select information of interest that is related to the displayed programming content within a predetermined region on a screen of the viewing appliance.

2. A television system comprising circuitry and software for enabling a content provider to receive, during a television program, at least one interactively generated request for selected information from a television program viewer, for storing and aggregating multiple requests received during the airing of the television program, and for delivering the selected information to the viewer for implementing a programming-related information store-and-forward functionality.

3. An on-screen area, region, window or stripe that is presented during television programming and that provides a programmer a capability to interactively engage a viewer so as to receive requests for information, where the information is related in some manner to the content of a program or a commercial, and to store-and-forward the requested information to the viewer.

4. An on-screen region configured as a stripe that overlays a predetermined portion of a television display screen, said stripe holding and presenting information that is contextual to television programming that it is overlayed on and cooperating with a system for providing televison viewer interactivity to provide the viewer with an ability to request the delivery of information that is related to a subject of, or a topic considered by, the television programming.

5. An on-screen region as in claim 4, wherein the on-screen region is selectively displayed only to those viewers who request that it be displayed.

6. An on-screen region as in claim 4, wherein said region is implemented in accordance with an Advanced Television Enhancement Forum (ATVEF) standard, wherein triggers are sent to a viewing appliance during Vertical Blanking Intervals (VBIs), wherein the predetermined on-screen region is operated by the triggers so to be present during television programming only when requested by a viewer and providing a programmer a capability to interactively engage the viewer.

7. A method for displaying a program, a commercial or a promotional message to a viewer of a viewing appliance, comprising:
transmitting a television signal such that a display screen displays live or pre-recorded audio/visual programming; and
opening a visually distinct on-screen area, region, window or stripe on the display screen, the on-screen area displaying information that provides the viewer with a capability to interactively obtain selected information from an information provider through a data communications network.

8. A method as in claim 7, comprising:
sending a first trigger signal from a server for prompting the viewer to select whether the viewer wishes to have the on-screen area displayed during a program and, if the viewer so wishes;
operating an input device for sending an affirmative signal to the viewing appliance;
the receipt of the affirmative signal causing the viewing appliance to send a response signal to the server that, in turn, sends a second trigger signal to the viewing appliance for causing the viewing appliance to open said visually distinct on-screen area, region, window or stripe on the display screen of the information appliance.

9. A method as in claim 7, wherein said visually distinct on-screen area, region, window or stripe is translucent or transparent so that a television program may be viewed through it.

10. A method as in claim 7, wherein said visually distinct on-screen area, region, window or stripe displays icons and text for offering the viewer an opportunity to obtain further information regarding some aspect of the content of a television program being viewed, and wherein upon the viewer indicating acceptance to the offer, sending a signal from the viewing appliance back to a server that in response to receiving the signal records the viewer's acceptance for that particular additional information, and repeating these steps during at least one television program, with the server storing and aggregating a record of the viewer's selections.

11. A method as in claim 10, wherein at or near the end of the television program the server sends a further trigger signal to the viewing appliance that causes the viewing appliance to open said visually distinct on-screen area, region, window or stripe for displaying summary information regarding the viewer's information selections.

12. A method as in claim 11, and further comprising steps of:
prompting the viewer to enter an indication of where the selected information is to be sent; and
forwarding the entered indication to the server so that the selected item(s) of information can be forwarded to the viewer.

13. A method as in claim 12, wherein the indication comprises at least one of a preassigned account number, a membership number and an address, such as an e-mail address or a physical street address.

14. A method as in claim 12, wherein the selected item(s) of information are forwarded to the viewer by a server associated with the television programmer.

15. A method as in claim 12, wherein the selected item(s) of information are forwarded to the viewer by a server associated with an advertiser that provides a commercial for use by the television programmer.

16. An on-screen area, region, window or stripe that is presented during television programming upon request by a viewer and that enables the viewer to initiate requests for specific items of information that are offered to the viewer through the on-screen area, region, window or stripe, where the information is related in some manner to the content of a program or a commercial currently being presented to the viewer, where a record of said viewer requests are stored for a given program enabling an information provider to store-and-forward the requested information in an electronic manner to the viewer.

17. An on-screen area, region, window or stripe as in claim 16, wherein said viewer is further provided with an opportunity to participate in an interactive application, such as a poll.

18. An on-screen area, region, window or stripe as in claim 16, where the information that can be requested through the on-screen area, region, window or stripe is intended to be relevant to all viewers of the television program.

19. An on-screen area, region, window or stripe as in claim 16, where the information that can be requested through the on-screen area, region, window or stripe is intended to be relevant to viewers within at least one predetermined demographic group.

20. An on-screen area, region, window or stripe as in claim 16, where the information that can be requested through the on-screen area, region, window or stripe is intended to be relevant to a particular viewer.
